(19) United States
(12) Patent Application Publication
(10) Pub. No.: US 2024/0220301 A1
(43) Pub. Date: Jul. 4, 2024

(54) DEPLOYMENT AND MANAGEMENT OF MICROSERVICES IN AN AIR-GAPPED ENVIRONMENT

(71) Applicant: VMware, Inc., Palo Alto, CA (US)

(72) Inventors: Mohan SITARAM, San Jose, CA (US); Giridhar Subramani JAYAVELU, San Francisco, CA (US); Steven Michael GEMELOS, San Jose, CA (US)

(21) Appl. No.: 18/150,067

(22) Filed: Jan. 4, 2023

(51) Int. Cl. G06F 9/455

(52) U.S. Cl. CPC G06F 9/45558; G06F 2009/4557; G06F 2009/45583

(57) ABSTRACT

The disclosure provides a method for deploying a product having a plurality of microservices in a container-based cluster. The method generally includes monitoring, by a first operator, for custom resources created for products that are to be deployed; monitoring, by a second operator, for custom resources created for microservices that are to be deployed; generating a first custom resource for the product representing a deployment and runtime configuration of the product, wherein the first custom resource defines a deployment specification for each of the plurality of microservices of the product; detecting, by the first operator, the first custom resource has been generated; creating, by the first operator, a corresponding second custom resource for each of the plurality of microservices of the product; detecting, by the second operator, the second custom resources created; and deploying each of the plurality of microservices in the container-based cluster based on the second custom resources.

Cloud native technologies, including microservices, have become a dominant force in software development and have proven to be vital to modem application delivery. In particular, the term microservices refers to an architectural approach to building applications. With a microservices architecture, an application is built as independent components that run each process of the application as a service. Services may be built for business capabilities, and each service may perform a single function. Because the services are independently run, each service can be updated, deployed, and/or scaled to meet demand for specific functions of an application. The microservices approach helps to enable teams to adapt more quickly to changing demands, as well as, accelerate the delivery of new software features.

Containers are commonly used for microservices because they provide a scalable, portable standalone package. In particular, a container is a package that relies on virtual isolation to deploy and run microservices/applications that access a shared operating system (OS) kernel. Containerized services run on a container orchestration platform that enables the automation of much of the operational effort required to run containers having services. This operational effort includes a wide range of things needed to manage a container's lifecycle, including, but not limited to, provisioning, deployment, scaling (up and down), networking, and load balancing. Kubernetes® (K8S®) software is an example open-source container orchestration platform that automates the operation of such containerized services.

As such, container orchestration platforms, such as Kubernetes, help to radically simplify and automate the deployment and management of highly complex microservices applications. For example, in some cases, an organization uses such a platform to manage dozens of clusters, with a correspondingly high number of applications, microservices, and/or containers running in those environments. Often these deployments run in hybrid cloud environments, adding the complexity of deploying and communicating across on-premise and multiple hosted clouds.

However, organizations in finance, healthcare, public sector agencies, and/or other highly regulated industries have added security and/or compliance requirements. Accordingly, there exists a need to balance the advantage of highly available, scalable, and redundant cloud-based environments with additional infrastructure restrictions such as, no public internet access and/or other high security standards. Such environments may be referred to as isolated or “air-gapped” environments.

An air-gapped environment is a network security measure employed to ensure a computing machine or network is secure by isolating (e.g., using a firewall) it from unsecured networks, such as the public Internet or an unsecured local area network. As such, a computing machine having containerized services running thereon may be disconnected from all other systems.

Because the network is isolated, air-gapped environments help to keep critical systems and sensitive information safe from potential data theft or security breaches. As another layer of protection, organizations can vet the container images that are allowed to run on these clusters to reduce the risk of a malicious attack. In addition, air-gapped environments can operate in low bandwidth or with a poor internet connection, ensuring the continuous availability of their mission-critical applications. While air-gapped environments offer many security and workflow advantages, they also introduce new challenges. These challenges are particularly present when deploying cloud native applications having an arbitrary number of constituent services in such restrictive environments. In particular, in air-gap deployments the installation and maintenance of microservices in the container-based cluster becomes increasingly complex. Isolated deployments require additional planning and implementation details to implement successfully.

For example, a container-based platform, such as a Kubernetes platform, is made up of a central database containing Kubernetes objects, or persistent entities, that are managed in the platform. Kubernetes objects are represented in configuration files and describe the state of a Kubernetes cluster of interconnected nodes (e.g., physical machines, or virtual machines (VMs) configured to run on physical machine(s) running a hypervisor) used to run containerized services (for different applications). The state of the cluster defines intended infrastructure (e.g., pods, containers, etc.) and applications/containerized services that are to be deployed in the cluster. One type of object used in Kubernetes to define the state of the Kubernetes cluster, includes custom resource definition (CRD) objects (also referred to herein as a “custom resources (CRs)”). A CRD object is an object that extends the Kubernetes application programming interface (API) or allows a user to introduce their own API into a Kubernetes cluster. The Kubernetes API is a resource-based (e.g., RESTful or representational state transfer architectural style) programmatic interface provided via HTTP. In particular, Kubernetes provides a standard extension mechanism, referred to as custom resource definitions, that enables extension of the set of resources and objects that can be managed in a Kubernetes cluster.

Such CRD objects may be used to create and deploy cloud native products composed of a large number of microservices. In particular, a unique CRD object may be defined and deployed for each microservice of the product. Thus, where a product requires upwards of forty containerized services (e.g., such as the Telco Cloud Service Assurance product), for example, forty CRD objects may be created, registered, and deployed in the Kubernetes cluster. Deploying and managing such a large number of custom resources can be difficult especially where a user wants to be able to tune and customize the configuration of one or more of these services at deployment time. The problem is further compounded when the environment where these custom resources are being deployed is in a private cloud/on-premises datacenter or in a demilitarized (DMZ) network that is cordoned off from the public internet by a firewall (i.e. air-gapped Kubernetes environments). Such limitations preclude the use of common continuous delivery (CD) mechanisms (e.g., used to help ensure that it takes minimal effort to deploy new software code) for software lifecycle management that are ubiquitous in the public cloud.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for deploying a product having a plurality of microservices in a container-based cluster. The method generally includes monitoring, by a first operator deployed in the container-based cluster, for custom resources created for products that are to be deployed in the container-based cluster; monitoring, by a second operator deployed in the container-based cluster, for custom resources created for microservices that are to be deployed in the container-based cluster; generating a first custom resource for the product, in the container-based cluster, representing a deployment and runtime configuration of the product, wherein the first custom resource defines a deployment specification for each of the plurality of microservices of the product; based on the monitoring, detecting, by the first operator, the first custom resource for the product has been generated; creating, by the first operator, a corresponding second custom resource for each of the plurality of microservices of the product based on the deployment specification defined for each of the plurality of microservices in the first custom resource; based on the monitoring, detecting, by the second operator, the second custom resources created for the plurality of microservices; and deploying each of the plurality of microservices in the container-based cluster based on the second custom resources.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1A illustrates a computing system in which embodiments described herein may be implemented.

FIG. 1B illustrates an example cluster for running containerized workloads in the computing system of FIG. 1A, according to an example embodiment of the present disclosure.

FIG. 2 illustrates example operations for deploying microservices in an air-gapped environment, according to an example embodiment of the present disclosure.

FIG. 3 illustrates an example product custom resource (CR), according to an example embodiment of the present disclosure.

FIG. 4 illustrates an example microservice CR created based on the product CR, according to an example embodiment of the present disclosure.

FIG. 5 shows a flow diagram depicting a method for deploying a product having a plurality of microservices in a container-based cluster, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for simplifying the deployment of cloud native products, having any number of constituent services, in a container-based cluster (e.g., such as a Kubernetes cluster) are described herein. The techniques may be particularly useful where the container-based cluster is running inside a restrictive environment, such as an air-gapped Kubernetes environment. Although described with respect to Kubernetes clusters and environments, the techniques described herein may similarly be applied to other container-based clusters and environments.

To provide a simplified, cloud native solution to product/microservice deployment and management, a new custom resource (CR), referred to herein as a “product CR,” is introduced. A product CR is a representation of a product's deployment and runtime configuration created for a product that is to be deployed in the Kubernetes cluster. The product CR defines different microservices that are to be created for the product and their interrelationship with respect to the Kubernetes cluster. As such, a product CR is a single artifact created to represent configurations of different microservices of a product that may be used for deployment of these microservices, as opposed to creating a single CR for deployment of each microservice of the product. The product CR may be created as a JavaScript Object Notation (JSON) file, a YAML file, and/or the like.

Further, to deploy and manage the product CR, two Kubernetes operators are introduced herein. A Kubernetes operator is an application-specific controller that extends the functionality of the Kubernetes API to create, configure, and/or manage instances of complex products on behalf of a Kubernetes user. More specifically, a Kubernetes operator uses custom controllers to monitor and track custom Kubernetes objects, referred to as CRD objects, to help ensure that the actual state of the cluster and the desired state of cluster are always in-sync within the cluster (e.g., via continuous monitoring of the CRD objects). Whenever the state of the cluster is different from what has been defined, a Kubernetes operator acts to reconcile the current state of the cluster.

A first Kubernetes operator, referred to herein as the admin operator, is configured to monitor for product CRs, of different products, that are deployed in a Kubernetes cluster where the admin operator is running. In response to the monitoring, the admin operator may detect that a product CR has been deployed and accordingly determine the deployment specification for microservices of the product associated with the product CR. Admin operator may use this information to create a microservice CR for each of the microservices defined in the product CR. After creation of the each microservice CR, control is then passed to a second Kubernetes operator.

The second Kubernetes operator, referred to herein as the Kapp operator, is configured to monitor for microservice CRs created by the admin operator. In response to the monitoring, the Kapp operator may detect that a microservice CR has been created and accordingly initiate deployment of a microservice defined by the microservice CR. Subsequently, the Kapp operator may transmit control of the microservice to Kubernetes controllers that run and manage controller processes in the Kubernetes cluster (e.g., Deployment controllers, StatefulSet controllers, etc.). For example, a Kubernetes control plane may have (e.g., four) control loops called controller processes, which watch the state of the cluster and try to modify the current state of the cluster to match an intended state of the cluster. Accordingly, the admin operator, the Kapp operator, and other Kubernetes controllers may be responsible for handling the deployment and lifecycle management of the individual constituent services of the product being deployed.

As such, by expressing a product, and all its microservices, as a single artifact (e.g., the product CR) and implementing both the admin operator and the Kapp operator in a Kubernetes cluster where the product is to be deployed, deployment of the product and its corresponding services may be automated and further simplified. For example to deploy a product having forty microservices, conventional approaches generally require a user to create and deploy a microservice CR for each of these forty microservices (e.g., such that forty microservice CRs are created and deployed manually by the user). Such techniques are both inefficient and result in a poor deployment experience for the user. Accordingly, the techniques presented herein provide improved techniques for deploying the product, having forty microservices, by only requiring the creation and deployment of a single CR, the product CR. Deploying the single CR may cause the Kubernetes operators, introduced herein, to automatically create microservice CRs for each of the microservices, based on the product CR, and deploy each of these microservice CRs in the Kubernetes cluster. Accordingly, a user may not need to instantiate each microservice individually.

This may be particularly useful in an air-gapped environment or private-cloud/on-premises data centers where a user wants to deploy and manage a product by him/herself without having to handle the deployment and lifecycle management of each of the individual constituent services which make up the product.

Additionally, by expressing a product specification as a Kubernetes CR, and more specifically, as the product CR, a profusion of tools built around Kubernetes may be available for the product/microservice deployment (and management). For example, the available tools may include complex cloud-native function (CNF) management tools such as Telco Cloud Automation (TCA) provided by VMware, CloudFormation provided by Amazon, and Terraform provided by HashiCorp, as well as simpler CNF management tools such as Helm provided by Microsoft (e.g., originally provided by Deis which was acquired by Microsoft), and kubectl (e.g., a Kubernetes command-line tool). Such tools may reduce the amount of work needed to deploy, upgrade, and/or manage products, and their corresponding microservices, in Kubernetes.

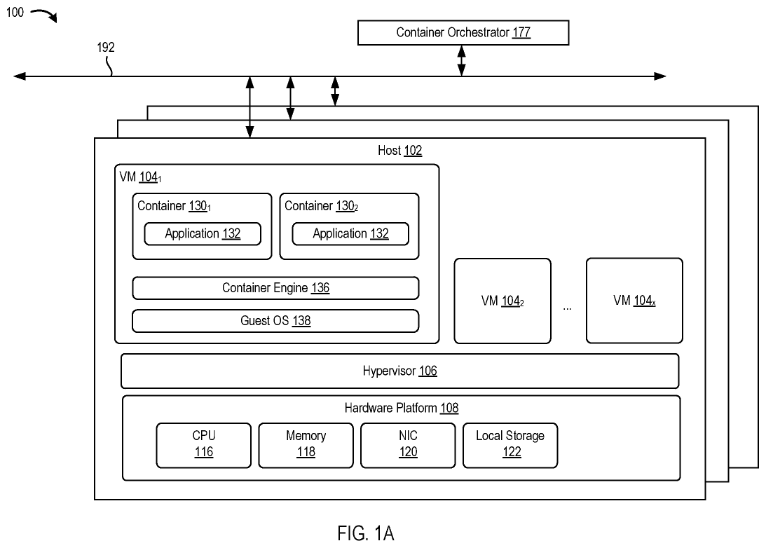

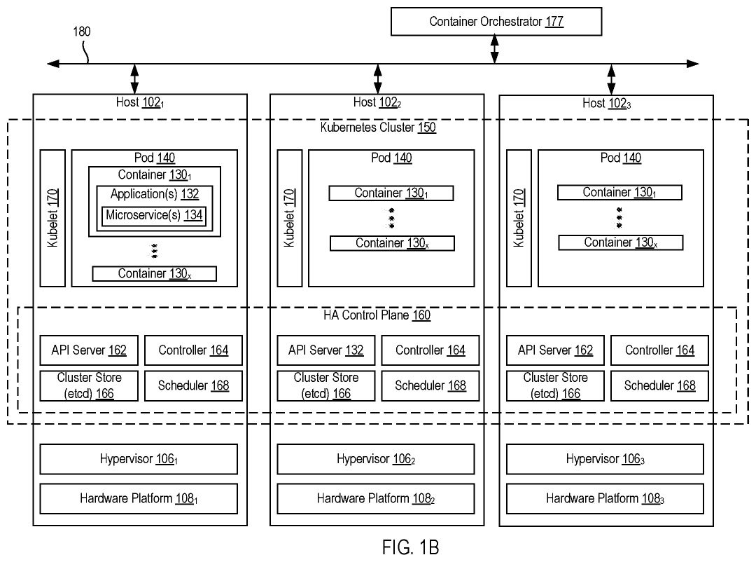

FIG. 1A is a block diagram that illustrates a computing system 100 in which embodiments described herein may be implemented. Computing system 100 includes one or more hosts 102 connected by a physical network 192. In particular, physical network 192 enables communication between hosts 102, and/or between other components and hosts 102.

Hosts 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 104₁ to 104_{N} (collectively referred to as VMs 104 and individually referred to as VM 104) that run concurrently on the same host 102.

Hardware platform 108 of each host 102 includes components of a computing device such as one or more processors (central processing units (CPUs)) 116, memory 118, a network interface card including one or more network adapters, also referred to as NICs 120, and/or storage 122. CPU 116 is configured to execute instructions that may be stored in memory 118 and, optionally, in storage 122.

In certain aspects, hypervisor 106 may run in conjunction with an operating system (not shown) in host 102. In some embodiments, hypervisor 106 can be installed as system level software directly on hardware platform 108 of host 102 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 106 implements one or more logical entities, such as logical switches, routers, etc. as one or more virtual entities such as virtual switches, routers, etc. In some implementations, hypervisor 106 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Each VM 104 implements a virtual hardware platform that supports the installation of a guest OS 138 which is capable of executing one or more applications. Guest OS 138 may be a standard, commodity operating system. Examples of a guest OS include Microsoft Windows, Linux, and/or the like.

In certain embodiments, each VM 104 includes a container engine 136 installed therein and running as a guest application under control of guest OS 138. Container engine 136 is a process that enables the deployment and management of virtual instances (referred to interchangeably herein as “containers”) by providing a layer of OS-level virtualization on guest OS 138 within VM 104. Containers 130₁ to 130_{Y} (collectively referred to as containers 130 and individually referred to as container 130) are software instances that enable virtualization at the OS level. That is, with containerization, the kernel of guest OS 138, or an OS of host 102 if the containers are directly deployed on the OS of host 102, is configured to provide multiple isolated user space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132 as a single executable package of software that bundles application code together with all of the related configuration files, libraries, and dependencies required for it to run. Application 132 may be any software program, such as a word processing program.

In certain embodiments, computing system 100 can include a container orchestrator 177. Container orchestrator 177 implements an orchestration control plane, such as Kubernetes, to deploy and manage applications and/or services thereof on hosts 102, of a host cluster, using containers 130. For example, Kubernetes may deploy containerized applications, and their corresponding microservices, as containers 130 and a control plane on a cluster of hosts. The control plane, for each cluster of hosts, manages the computation, storage, and memory resources to run containers 130. Further, the control plane may support the deployment and management of applications (or microservices) on the cluster using containers 130. In some cases, the control plane deploys applications as pods of containers running on hosts 102, either within VMs or directly on an OS of the host. An example container-based cluster for running containerized applications is illustrated in FIG. 1B. While the example container-based cluster shown in FIG. 1B is a Kubernetes cluster 150, in other examples, the container-based cluster may be another type of container-based cluster based on container technology, such as Docker® clusters.

As illustrated in FIG. 1B, Kubernetes cluster 150 is formed from a combination of one or more pods 140 including one or more containers 130 (e.g., for running applications 132 and/or microservices 134), one or more kubelets 170, and a control plane 160. Further, although not illustrated in FIG. 1B, Kubernetes cluster 150 may include one or more kube proxies. A kube proxy is a network proxy that runs on each host 102 in Kubernetes cluster 150 that is used to maintain network rules. These network rules allow for network communication with pods 140 from network sessions inside and/or outside of Kubernetes cluster 150.

Kubelet 170 on each host 102 is an agent that helps to ensure that one or more pods 140 run on each host 102 according to a defined state for the pods 140, such as defined in a configuration file. Each pod 140 may include one or more containers 130.

Control plane 160 includes components such as an application programming interface (API) server 162, a cluster store (etcd) 166, a controller 164, and a scheduler 168. Control plane 160's components make global decisions about Kubernetes cluster 150 (e.g., scheduling), as well as detect and respond to cluster events (e.g., starting up a new pod 140 when a workload deployment's replicas field is unsatisfied).

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. kube-apiserver is designed to scale horizontally-that is, this component scales by deploying more instances. Several instances of kube-apiserver may be run, and traffic may be balanced between those instances.

Cluster store (etcd) 166 is a data store, such as a consistent and highly-available key value store, used as a backing store for Kubernetes cluster 150 data. In certain aspects, cluster store (etcd) 166 stores a configuration file made up of one or more manifests that declare intended system infrastructure and microservices 134 (for application(s) 132) to be deployed in Kubernetes cluster 150. In certain aspects, the manifests are JSON and/or YAML files.

Controller 164 is a control plane 160 component that runs and manages controller processes in Kubernetes cluster 150. As described above, control plane 160 may have (e.g., four) control loops called controller processes, which watch the state of Kubernetes cluster 150 and try to modify the current state of Kubernetes cluster 150 to match an intended state of Kubernetes cluster 150.

Scheduler 168 is a control plane 160 component configured to allocate new pods 140 to hosts 102. Additionally, scheduler 168 may be configured to distribute applications 132/microservices 134, across containers 130, pods 140, and/or hosts 102 that are assigned to use resources of hardware platform 108. Resources may refer to processor resources, memory resources, networking resources, and/or the like. In some cases, scheduler 168 may schedule newly created containers 130 to one or more of the hosts 102.

In other words, control plane 160 manages and controls every component of Kubernetes cluster 150. Control plane 160 handles most, if not all, operations within Kubernetes cluster 150, and its components define and control Kubernetes cluster 150's configuration and state data. Control plane 160 configures and runs the deployment, management, and maintenance of the containerized applications 132, and in some cases, their corresponding microservices 134. As such, ensuring high availability of the control plane may be critical to container deployment and management. High availability is a characteristic of a component or system that is capable of operating continuously without failing.

Accordingly, in certain aspects, control plane 160 may operate as a high availability (HA) control plane. Additional details of HA control planes are disclosed in U.S. Application Ser. No. 63/347,815, filed on Jun. 1, 2022, and titled “AUTONOMOUS CLUSTERS IN A VIRTUALIZATION COMPUTING ENVIRONMENT,” which is hereby incorporated by reference herein in its entirety.

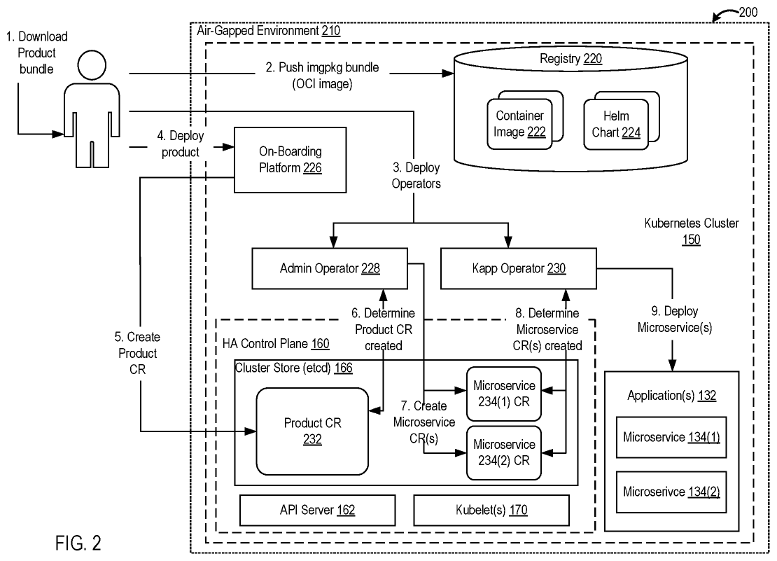

In certain aspects, Kubernetes cluster 150 further includes an admin operator 228 and a Kapp operator 230 (e.g., illustrated in FIG. 2) instantiated as services for the deployment and management of microservices 134 for a product deployed in Kubernetes cluster 150. In certain aspects, admin operator 228 and Kapp operator 230 are microservices running on containers in Kubernetes cluster 150. Example operations 200 for deploying microservices of a product in Kubernetes cluster 150 are described in detail with respect to FIG. 2.

As illustrated in FIG. 2, Kubernetes cluster 150 is instantiated on interconnected nodes (e.g., hosts 102 and/or VMs 104) running in an air-gapped environment 210. A product intended for deployment in Kubernetes cluster 150 (e.g., by a Kubernetes user) is composed of several microservices 134. For ease of explanation, and not meant to be limiting to this particular example, it may be assumed that the product intended for deployment in Kubernetes cluster 150 is a product composed of forty microservices 134.

To deploy the example product, as shown at a first operation in FIG. 2, a user may download a bundle for the product. The bundle may be a single open container initiative (OCI) artifact, or more specifically, an OCI image (e.g., the OCI defines the specifications and standards for container technologies). The bundle may capture configuration files created for the product and a list of references to OCI images on which the configuration files depend. In certain aspects, an image package (imgpkg) tool is used to compile and store the set of arbitrary configuration files as the OCI image. The configuration files may take many forms including YAML configurations, helm charts, ytt templates, JSON templates, and/or the like.

At a second operation, the downloaded product bundle may be transmitted to a registry 220 for storage. Registry 220 may be used to store, share, and manage container images 222 and/or helm charts 224 for, at least, microservices 134 of the product. Container images 222 are static bundles of files that represent everything a container runtime needs to run a container. Helm charts 224 are collections of files that describe related sets of Kubernetes resources. A single helm chart may be used to deploy something simple, such as a memcached pod, or something more complex, such as a full web app stack with HTTP servers, databases, caches, etc.

At a third operation, the user deploys admin operator 228 and Kapp operator 230 in Kubernetes cluster 150. As described above, these operators may be instantiated as services to allow for the efficient and automated deployment of the product comprising forty microservices in Kubernetes cluster 150.

At a fourth operation, the user manually deploys the product. In certain aspects, the product is deployed as helm charts. At a fifth operation, an onboarding platform 226 is configured to automatically create a product CR 232 for the product being deployed. Example onboarding platforms 226 configured to create product CR 232 include TCA provided by VMware, CloudFormation provided by Amazon, Terraform provided by HashiCorp, and/or a helm command line interface (CLI) provided by Helm.

Product CR 232 created by onboarding platform 226 may be a representation of the product's deployment and runtime configuration. The created product CR 232 may define the forty different microservices that are to be created for the product and their interrelationship with respect to Kubernetes cluster 150. Product CR 232 may be created and stored in cluster store (etcd) 166.

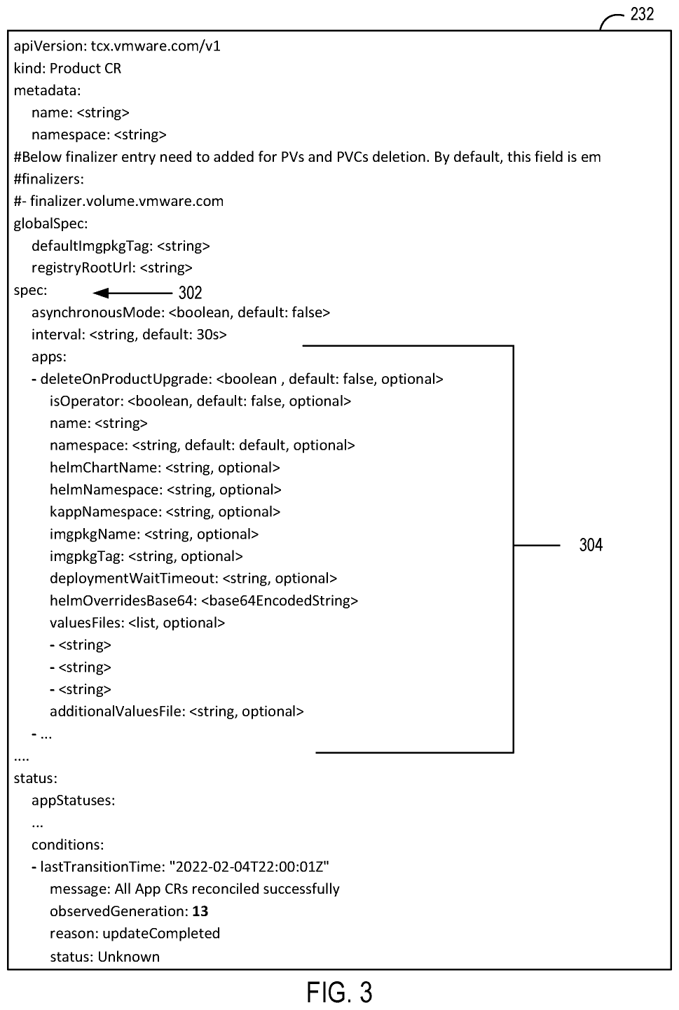

FIG. 3 illustrates an example product CR 232, according to an example embodiment of the present disclosure. As shown at 302, product CR 232, created by onboarding platform 226 illustrated in FIG. 2, comprises a spec field. The spec field may have one or more apps sub-fields. Parameters under each apps sub-fields define the deployment specification for a single microservice 134 of the product associated with the product CR 232 being created. Thus, an apps sub-field with defined parameters (e.g., shown as 304) may be created for each microservice 134 of the product. For the example illustrated in FIG. 2, product CR 232 may include forty apps sub-fields, with parameters, 304, where each apps sub-field 304 is created for a single microservice 134.

Parameters defined for each microservice 134 may include a name of the microservice 134 and/or a namespace where the microservice 134 (and its corresponding microservice CR) is to be deployed. Additional parameters may include imgpkgName and/or imgpkgTag. Parameter imgpkgName is the name of the imgpkg bundle to be used for deploying the microservice 134, and parameter imgpkgTag is the registry tag of the imgpkg bundle to use for deploying the microservice 134. Defined parameters may also include a helmChartName, helmNamespace, and/or kappNamespace. Parameter helmChartName is the name of the microservice 134's helm chart within the imgpkg bundle, helmNamespace is the namespace to be provided for rendering the helm chart, and kappNamespace is the namespace into which all resources will be deployed. In some cases, the defined parameters include parameter deploymentWaitTimeout which indicates the time to wait for a microservice CR 234, created for this microservice 134, to deploy. In some cases, the defined parameters include parameter isOperator which indicates whether the microservice 134 is an operator (e.g., operator microservices 134 are deleted last during product uninstallation). In some cases, the defined parameters include parameter helmOverridesBase64 which indicates the deployment time override encoded in base64. In some cases, the defined parameters include parameter valuesFiles which is a list of values that indicates an order of parameter overrides based on the order in which the parameter appears in the list. In some cases, the defined parameters include parameter deleteOnProductUpgrade. Where parameter deleteOnProductUpgrade is set to “true,” the microservice CR 234 created for this microservice 134 is to be deleted during a product CR 232 upgrade. Parameters identified in example product CR 232 illustrated in FIG. 2 are not exhaustive, and other parameters may be considered for other apps sub-fields and/or other product CRs 232 created.

Returning to FIG. 2, in certain aspects, admin operator 228 (e.g., previously deployed by the user at the third operation) is configured to monitor for custom resources, and more specifically product CRs 232, created and deployed for different products in Kubernetes cluster 150. Thus, based on the monitoring, at a sixth operation, admin operator 228 may determine that product CR 232 exists in cluster store (etcd) 166 when on-boarding platform 226 creates product CR 232. Admin operator 228 may use information contained in product CR 232 to determine a deployment specification defined for each of the forty microservices 134. Based on this information contained in product CR 232, admin operator 228 may create a microservice CR 234 for each microservice 134. In this example, because the product CR 232 defines a deployment specification for forty microservices 134 which make up the product being deployed, admin operator 228 may create forty microservice CRs 234, where each microservice CR 234 corresponds to one microservice 134 of the product. Each microservice CR 234 may represent an intended state of a corresponding microservice 134 that is to be deployed in Kubernetes cluster 150.

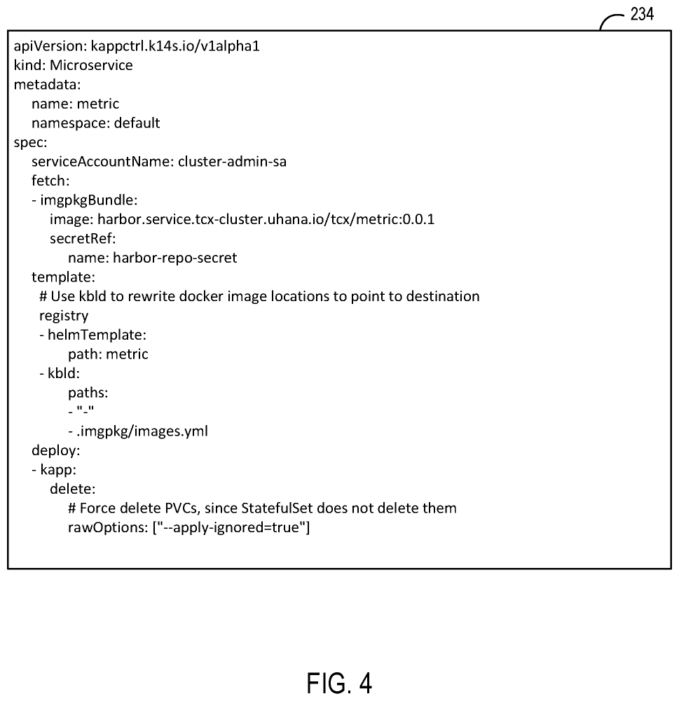

FIG. 4 illustrates an example microservice CR 234 created based on an example product CR. As illustrated in FIG. 4, microservice CR 234 is created with name “metric” and is deployed in namespace “default.” As described above with respect to example product CR 232 illustrated in FIG. 3, the name and namespace for deploying microservice CR 234 (and correspondingly microservice 134) that are present in microservice CR 234 may be defined in product CR 232.

In some cases, example microservice CR 234 includes a spec field having fetch, imgpkgBundle, and template sub-fields. These sub-fields in microservice CR 234 are created by admin operator 228 and are used to provide instructions to Kapp operator 230 for deploying this microservice 134. In other words, information included in the sub-fields are directives for Kapp operator 230.

Returning to FIG. 2, in certain aspects, Kapp operator 230 (e.g., previously deployed by the user at the third operation) is configured to monitor for custom resources, and more specifically microservice CRs 234, created and deployed for different microservices 134 of different products in Kubernetes cluster 150. Thus, based on the monitoring, at an eighth operation, Kapp operator 230 may determine that forty microservice CRs 234 have been created and exist in cluster store (etcd) 166 when admin operator 228 creates these microservice CRs 234. Kapp operator 230, using its controller, may deploy contents of a helm chart for each microservice 134 corresponding to a microservice CR 234 detected by Kapp operator 228. In other words, Kapp operator 230 may deploy the actual software for each microservice 134, and in some cases, deploy containers for running these microservices 134.

Subsequently, Kapp operator 230 may transfer control of the microservices 134 to native Kubernetes controllers, such as a Deployment controller, a StatefulSet controller, a ReplicaSets controller, and/or the like. The native Kubernetes controllers may be configured to watch the state of Kubernetes cluster 150, and then make and/or request changes where needed. Each controller makes effort to move the current cluster state closer to the desired state.

In some cases, the native Kubernetes controllers relay the status of their respective resources back to Kapp Operator 230 which in turn relays the status of each microservice CR 234 back to admin operator 228. Admin operator 228 may update the status of product CR 232, which is read and observed by a user of Kubernetes cluster 150 to infer the state of the entire product.

As illustrated by operations 200, by expressing a product, and all its microservices 134, as a single product CR 232 and implementing both the admin operator 228 and the Kapp operator 230 in Kubernetes cluster 150 where the product is to be deployed, deployment of the product and its corresponding microservices 134 may be automated. As such, where the product (and its microservices 134) are to be deployed in multiple different places, deployment of the product may be simplified, thereby allowing for increased scalability in deployment. Further, should a user need to make a change to one or more microservices, a user may make such changes by merely making revising one or more parameters used in creating the product CR 232. Admin operator 228 may watch for such change and apply the change to one or more microservice CRs 234. Accordingly, the techniques described herein help to improve microservice deployment and management experience for a user.

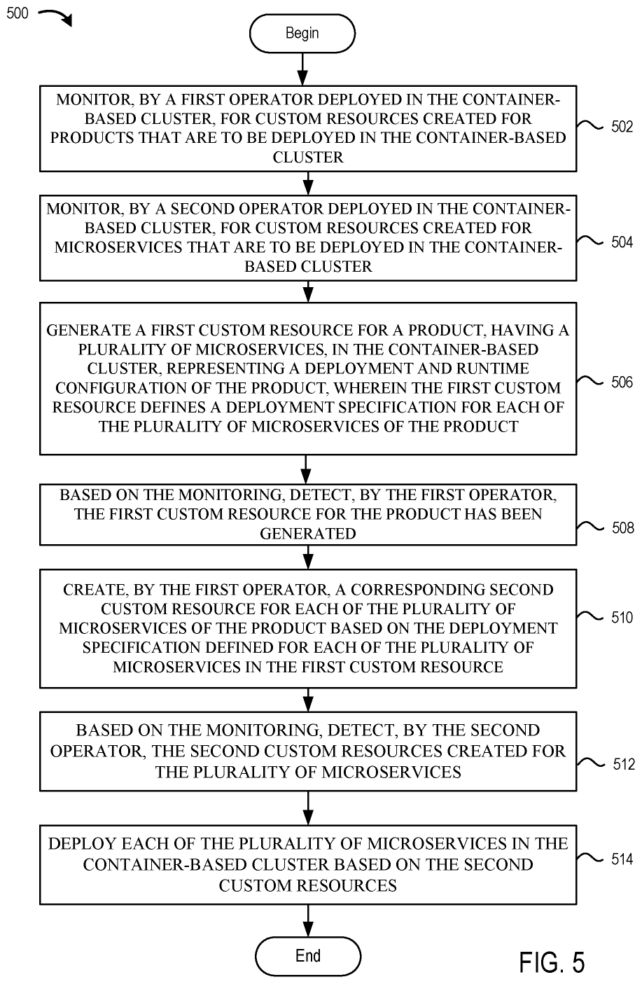

FIG. 5 shows a flow diagram depicting a method for deploying a product having a plurality of microservices in a container-based cluster, according to an example embodiment of the present disclosure.

As illustrated, operations 500 begin at block 502, a first operator, deployed in the container-based cluster, monitoring for custom resources created for products that are to be deployed in the container-based cluster.

At block 504, operations 500 proceed with, a second operator, deployed in the container-based cluster, monitoring for custom resources created for microservices that are to be deployed in the container-based cluster.

At block 506, operations 500 proceed with generating a first custom resource for the product, in the container-based cluster, representing a deployment and runtime configuration of the product, wherein the first custom resource defines a deployment specification for each of the plurality of microservices of the product (e.g., shown at the fifth operation in FIG. 2).

At block 508, operations 500 proceed with detecting, by the first operator, based on the monitoring, the first custom resource for the product has been generated (e.g., shown at the sixth operation in FIG. 2).

At block 510, operations 500 proceed with the first operator creating a corresponding second custom resource for each of the plurality of microservices of the product based on the deployment specification defined for each of the plurality of microservices in the first custom resource (e.g., shown at the seventh operation in FIG. 2).

At block 512, operations 500 proceed with detecting, by the second operator, based on the monitoring, the second custom resources created for the plurality of microservices (e.g., shown at the eighth operation in FIG. 2).

At block 514, operations 500 proceed with deploying each of the plurality of microservices in the container-based cluster based on the second custom resources (e.g., shown at the ninth operation in FIG. 2).

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these **necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for deploying a product having a plurality of microservices in a container-based cluster, the method comprising:
monitoring, by a first operator deployed in the container-based cluster, for custom resources created for products that are to be deployed in the container-based cluster;
monitoring, by a second operator deployed in the container-based cluster, for custom resources created for microservices that are to be deployed in the container-based cluster;
generating a first custom resource for the product, in the container-based cluster, representing a deployment and runtime configuration of the product, wherein the first custom resource defines a deployment specification for each of the plurality of microservices of the product;
based on the monitoring, detecting, by the first operator, the first custom resource for the product has been generated;
creating, by the first operator, a corresponding second custom resource for each of the plurality of microservices of the product based on the deployment specification defined for each of the plurality of microservices in the first custom resource;
based on the monitoring, detecting, by the second operator, the second custom resources created for the plurality of microservices; and
deploying each of the plurality of microservices in the container-based cluster based on the second custom resources.

2. The method of claim 1, further comprising:
determining, by the first operator, that the deployment specification for at least one microservice of the plurality of microservices defined in the first custom resource has been modified; and
updating the corresponding second custom resource for the at least one microservice based on the modified deployment specification.

3. The method of claim 1, wherein:
the first custom resource comprises an apps field for each of the plurality of microservices, and
each of the apps fields comprises parameters defined for a corresponding microservice.

4. The method of claim 3, wherein the parameters comprise at least one of:
a name of the corresponding microservice,
a namespace where the corresponding microservice is to be deployed,
a name of an image package bundle to be used for deploying the corresponding microservice,
a registry tag associated with the image package bundle,
a name of a helm chart for the corresponding microservice,
a namespace to be provided for rendering the helm chart,
a namespace where resources for the corresponding microservice are to be deployed, an indication that the corresponding microservice is an operator,
a deployment time override,
an indication that the second custom resource created for the corresponding microservice is to be deleted during an upgrade to the first custom resource, or
an indication of a period of time to wait for deployment of the corresponding microservice.

5. The method of claim 1, wherein the second custom resource for each of the plurality of microservices of the product provides instructions for deploying the corresponding microservice.

6. The method of claim 1, wherein the container-based cluster is running in an air-gapped environment.

7. The method of claim 1, wherein the container-based cluster is a set of one or more containers of one or more pods running on one or more nodes.

8. A system comprising:
one or more processors; and
at least one memory, the one or more processors and the at least one memory configured to:
monitor, by a first operator deployed in a container-based cluster, for custom resources created for products that are to be deployed in the container-based cluster;
monitor, by a second operator deployed in the container-based cluster, for custom resources created for microservices that are to be deployed in the container-based cluster;
generate a first custom resource for the product, in the container-based cluster, representing a deployment and runtime configuration of the product, wherein the first custom resource defines a deployment specification for each of the plurality of microservices of the product;
based on the monitoring, detect, by the first operator, the first custom resource for the product has been generated;
create, by the first operator, a corresponding second custom resource for each of the plurality of microservices of the product based on the deployment specification defined for each of the plurality of microservices in the first custom resource;
based on the monitoring, detect, by the second operator, the second custom resources created for the plurality of microservices; and
deploy each of the plurality of microservices in the container-based cluster based on the second custom resources.

9. The system of claim 8, wherein the one or more processors and the at least one memory are further configured to:
determine, by the first operator, that the deployment specification for at least one microservice of the plurality of microservices defined in the first custom resource has been modified; and
update the corresponding second custom resource for the at least one microservice based on the modified deployment specification.

10. The system of claim 8, wherein:
the first custom resource comprises an apps field for each of the plurality of microservices, and
each of the apps fields comprises parameters defined for a corresponding microservice.

11. The system of claim 10, wherein the parameters comprise at least one of:
a name of the corresponding microservice,
a namespace where the corresponding microservice is to be deployed,
a name of an image package bundle to be used for deploying the corresponding microservice,
a registry tag associated with the image package bundle,
a name of a helm chart for the corresponding microservice,
a namespace to be provided for rendering the helm chart,
a namespace where resources for the corresponding microservice are to be deployed, an indication that the corresponding microservice is an operator,
a deployment time override,
an indication that the second custom resource created for the corresponding microservice is to be deleted during an upgrade to the first custom resource, or
an indication of a period of time to wait for deployment of the corresponding microservice.

12. The system of claim 8, wherein the second custom resource for each of the plurality of microservices of the product provides instructions for deploying the corresponding microservice.

13. The system of claim 8, wherein the container-based cluster is running in an air-gapped environment.

14. The system of claim 8, wherein the container-based cluster is a set of one or more containers of one or more pods running on one or more nodes.

15. A non-transitory computer-readable medium comprising instructions that, when executed by one or more processors of a computing system, cause the computing system to perform operations for deploying a product having a plurality of microservices in a container-based cluster, the operations comprising:
monitoring, by a first operator deployed in the container-based cluster, for custom resources created for products that are to be deployed in the container-based cluster;
monitoring, by a second operator deployed in the container-based cluster, for custom resources created for microservices that are to be deployed in the container-based cluster;
generating a first custom resource for the product, in the container-based cluster, representing a deployment and runtime configuration of the product, wherein the first custom resource defines a deployment specification for each of the plurality of microservices of the product;
based on the monitoring, detecting, by the first operator, the first custom resource for the product has been generated;
creating, by the first operator, a corresponding second custom resource for each of the plurality of microservices of the product based on the deployment specification defined for each of the plurality of microservices in the first custom resource;
based on the monitoring, detecting, by the second operator, the second custom resources created for the plurality of microservices; and
deploying each of the plurality of microservices in the container-based cluster based on the second custom resources.

16. The non-transitory computer-readable medium of claim 15, wherein the operations further comprise:
determining, by the first operator, that the deployment specification for at least one microservice of the plurality of microservices defined in the first custom resource has been modified; and
updating the corresponding second custom resource for the at least one microservice based on the modified deployment specification.

17. The non-transitory computer-readable medium of claim 15, wherein:
the first custom resource comprises an apps field for each of the plurality of microservices, and
each of the apps fields comprises parameters defined for a corresponding microservice.

18. The non-transitory computer-readable medium of claim 17, wherein the parameters comprise at least one of:
a name of the corresponding microservice,
a namespace where the corresponding microservice is to be deployed,
a name of an image package bundle to be used for deploying the corresponding microservice,
a registry tag associated with the image package bundle,
a name of a helm chart for the corresponding microservice,
a namespace to be provided for rendering the helm chart,
a namespace where resources for the corresponding microservice are to be deployed, an indication that the corresponding microservice is an operator,
a deployment time override,
an indication that the second custom resource created for the corresponding microservice is to be deleted during an upgrade to the first custom resource, or
an indication of a period of time to wait for deployment of the corresponding microservice.

19. The non-transitory computer-readable medium of claim 15, wherein the second custom resource for each of the plurality of microservices of the product provides instructions for deploying the corresponding microservice.

20. The non-transitory computer-readable medium of claim 15, wherein the container-based cluster is running in an air-gapped environment.
